(19) United States
(12) Patent Application Publication
(10) Pub. No.: US 2015/0277571 A1
(43) Pub. Date: Oct. 1, 2015

(54) USER INTERFACE TO CAPTURE A PARTIAL SCREEN DISPLAY RESPONSIVE TO A USER GESTURE

(71) Applicant: Kobo Incorporated, Toronto (CA)

(72) Inventor: Benjamin LANDAU, Toronto (CA)

(73) Assignee: Kobo Incorporated, Toronto (CA)

(21) Appl. No.: 14/231,132

(22) Filed: Mar. 31, 2014

(51) Int. Cl. G06F 3/01; G06F 3/0484

(52) U.S. Cl. CPC G06F 3/017; G06F 3/04842

(57) ABSTRACT

System and method of selecting a portion of a screen display for a manipulation operation according to boundaries set by a user gesture. A touchscreen display is configured to display digital content and detect a multi-touch user gesture. If the user gesture dwells on the touchscreen longer than a first threshold time, a region of the screen display is selected based on the contact points of the user gesture on the touchscreen display. Accordingly an on-screen mask indicating the selected region is displayed, denoting the selected region to be active for a subsequent manipulation operation. The manipulation operation may be capturing a screenshot of the selected region or editing the image or text encompassed by the selected region.

### TECHNICAL FIELD

The present disclosure relates generally to the field of image manipulation, and, more specifically, to the field of user interfaces for image manipulation.

### BACKGROUND

A screenshot (or a screen capture) refers to an image copying the visible objects being displayed on a computer system’ display screen. Typically, screenshots can be generated by using the operating system or software running on an associated computing device in response to a user request on, such as desktop, laptop, smart phone, touchpad, tablet, e-reader, and so on.

According to numerous existing techniques, a user usually submits a screen capture request using a hard key installed on the computing device or a soft key defined by the operating system or a software program. For example, on some Windows operating systems, pressing the “PrtScr” key on the keyboard leads to capturing a screenshot of the desktop. The captured screenshot is then placed in the clipboard and thereby made available for subsequent manipulation by additional editing program. For another example, on an e-reader device (e.g., Amazon Kindle), a user needs to concurrently press and hold a volume button and the power button on the device to capture a screen display. The captured screenshot can be automatically saved to a default folder.

However, the user is only allowed to capture a screenshot encompassing the entire view of the instant screen display or of an active window, which often includes unwanted visual content, such as a tool bar, a white space, descriptive text accompanying an image, and a particular area of an image. To obtain an image having only the wanted portion of a screen view, a user has to either carefully adjust the currently displayed content, for example by expanding it until the wanted portion fills the screen, or by cropping a captured image by using a photo editing program. Either approach demands a plurality of concurrent or sequential user input actions and may not provide a satisfactory screenshot instantly. The existing art lacks a simplified and intuitive mechanism allowing a user to obtain a screenshot of a partial screen display instantly.

In a broader context, to crop any image being displayed also requires multiple user input actions according to the conventional approach. Usually, a user needs to select and open a photo editing program, select the crop function button, adjust a crop window (or mask) size, and confirm to crop the image, and then save the modified image. Thus, in general, there lacks an intuitive mechanism allowing a user to select a portion of an image and make it active for user manipulation.

### SUMMARY OF THE INVENTION

Therefore, it would be advantageous to provide a method and system to facilitate a user to capture a screenshot for a selected portion of a screen display.

Embodiments of the present disclosure employ a computer implemented method of selecting a portion of a displayed digital content for a manipulation operation according to boundaries set by a multi-point user gesture. A touchscreen display is configured to display digital content and detect a user multi-point touch gesture that defines a subset area of the display. If the user gesture dwells on the touchscreen longer than a first threshold time, a region of the displayed digital content is selected based on the contact points of the user gesture on the touchscreen display. For example, detection of a four-finger dwell gesture may result in a rectangular region with four corners coinciding with the four contact points. Accordingly an on-screen mask bordering the selected region is displayed to provide user feedback as to the selected subset area, denoting the selected region to be active for a subsequent manipulation operation.

The manipulation operation may be a screenshot capture of the selected region or an editing operation on the image/text contained in the selected region. A user can interact with the on-screen mask to adjust the size and location of the select region. Thereby, a user can conveniently select an intended portion of a screen display for a manipulation operation by using a simply and intuitive hand gesture.

In one embodiment, a computer implemented method of generating images comprises: (1) receiving indications of a multi-touch user gesture detected via said touch sensitive display device of a computer system, wherein said indications indicate touch locations of said multi-touch user gesture with said touch sensitive display device; (2) based on said touch locations, determining a region within a display area of said touch sensitive display device; (3) rendering an on-screen mask indicating boundaries of said region; and (4) upon occurrence of a predetermined event, generating image data capturing only a portion of a screen image being displayed on said touch sensitive display device, said portion encompassed by said region.

In one embodiment, the multi-touch user gesture may define four touch locations, and accordingly a rectangular region can be determined with four corners coincident with the four touch locations. The predetermined event may be a determination that said multi-touch user gesture dwells, e.g., touch points do not move, on said touch sensitive display device for at least a predetermined duration. The method may further comprise rendering said image data to display on said touch sensitive display device in full screen. The image data may be saved as an image file to a default directory of said computing system. The method may further comprise removing said on-screen mask responsive to said multi-touch user gesture leaving said touch sensitive display device without detecting said predetermined event.

In another embodiment of the present disclosure, a non-transitory computer-readable storage medium embodies instructions that, when executed by a processing device, cause the processing device to perform a method of capturing an image of a touch display. The method comprises: (1) receiving indications of a multi-point gesture detected via a said touch display, wherein said indications provide contact positions of said multi-point gesture on said touch display; (2) based on said contact positions, determining a rectangular display region within said touch display; (3) rendering an on-screen mask indicating boundaries of said rectangular display region; and (4) responsive to a user input event, providing a partial screen display that is being displayed on said touch display and contained within said on-screen mask to a manipulation operation.

In another embodiment of the present disclosure, a system comprises: a touch sensitive display device configured to detect user gesture input; a processor coupled to said touch sensitive display device; and memory coupled to said processor and comprising instructions that, when executed by said processor, cause the system to perform a graphical user interface method. The method comprises: (1) receiving indications of a multi-touch gesture detected via said touch sensitive display device, wherein said indications indicate touch locations of said multi-touch gesture with said touch sensitive display device; (2) based on said touch locations, determining a capture region within said touch sensitive display device; (3) rendering an on-screen mask indicating boundaries of said capture region; and (4) responsive to a user instruction, capturing an image within a portion of said touch sensitive display device being displayed, said portion encompassed by said capture region.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a flow chart depicting an exemplary computer implemented method of selecting a screen display region for a manipulation operation responsive to a multi-point user gesture in accordance with an embodiment of the present disclosure.

FIG. 2 is a flow chart depicting an exemplary computer implemented method of capturing only a portion of a screen image being displayed on a touchscreen display according to an embodiment of the present disclosure.

FIG. 3A illustrates a scenario that a user selects a portion of a screen display to capture a screenshot thereof by using a four-point touch gesture in accordance with an embodiment of the present disclosure.

FIG. 3B illustrates the full screen display of the capture screenshot in accordance with an embodiment of the present disclosure.

FIG. 4 illustrates an on-screen graphical user interface including a text portion that is selected for a highlighting operation responsive to a user gesture in accordance with an embodiment of the present disclosure.

FIG. 5 illustrates various exemplary predetermined masks prompted by different touch gestures in accordance with embodiments of the present disclosure.

FIG. 6 is a block diagram illustrating an exemplary computing system including a screenshot program configured to capture a partial screen display responsive to a user touch gesture according to an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### User Interface to Capture a Partial Screen Display Responsive to a User Gesture

Overall, embodiments of the present disclosure employ a computer implemented method of selecting a region on a screen display responsive to a multi-point user touch gesture for a subsequent manipulation operation. Once selected, the image may be used to, e.g., save to memory, email, etc. he selected region is determined based on the contact points on the touchscreen display. An on-screen mask is rendered on the touchscreen display to indicate the boundaries of the selected region. The mask may be altered by moving the gesture points. Upon occurrence of a user instruction event, the selected region of the screen display can be captured as a screenshot or edited. In some embodiments, the user instruction event is simply a determination that the user touch gesture dwells on the same contact points continuously at least for a predetermined amount of time.

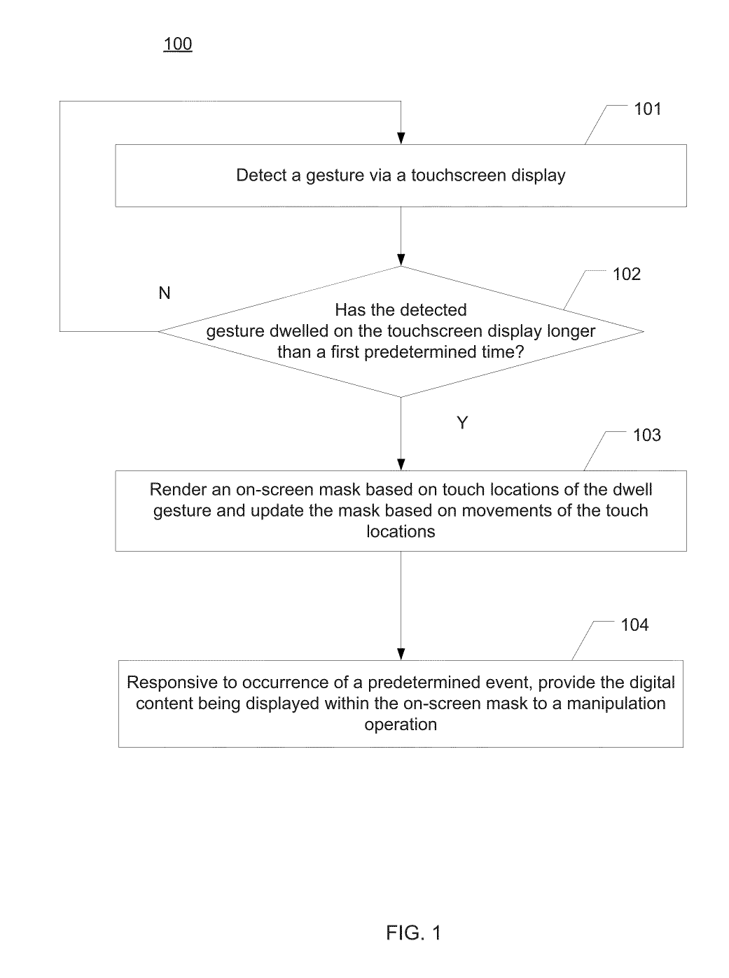

FIG. 1 is a flow chart depicting an exemplary computer implemented method 100 of selecting a screen display region for a manipulation operation responsive to a user gesture in accordance with an embodiment of the present disclosure. Method 100 can be implemented as a part of an operating system and/or an application program running on a computing device that is equipped with a touchscreen display. At 101, indications of a multi-point user gesture detected via the touchscreen display are received. It will be appreciated that the indications convey information regarding various attributes of the gesture, including the contact locations and dwell time on the touchscreen display. Dwell refers to the contact locations of the multipoint gesture not moving.

If it is determined that the gesture has dwelled on the touchscreen display for a predetermined amount of time at 102, the gesture is interpreted as a user instruction to select the region on the screen display. Hence, an on-screen mask (or capture mask) bordering the selected region is rendered on the touchscreen display based on the touch locations of the gesture. For example, if there are four touch points are detected, the gesture is interpreted to define a rectangle having four corners located approximately by the touch points. As will be described in greater detail, any other suitable gesture can also be used to define a select region according to a predetermined method.

However, if it is determined that the gesture touch left the touchscreen display before the predetermined amount of time at 102, the mask is removed from display.

Further, the user can alter the selected region before the selection is committed. It will be appreciated that a selected region can be altered in any suitable manner based on user input that is well known in the art. For example, a drag gesture applied on the mask and a pinch-in or pinch-out gesture applied inside the selected region can both be used to change the shape and location of the selected region. In general, the mask will change size and location responsive to movements in the touch locations.

At 104, responsive to an occurrence of a predetermined event, the digital content being displayed within the mask is provided to a manipulation operation. Thereby, a user conveniently selects an intended portion of a screen display for a manipulate operation by using a simple and intuitive gesture. In one embodiment, the predetermined event is a dwell of the gesture for a predetermined threshold of time.

The present disclosure is not limited to any specific manipulation operation to be performed following the selection of a screen display region. In some embodiments, a screenshot on the selected portion of the screen display can be captured instantly. Then the captured image may be displayed in full screen and/or saved to a gallery folder, or transmitted to another computer, e.g., email or text message, etc. In such embodiments, method 100 can be implemented as an integral part of the operating system that supports the touchscreen display as well as the associated computer system. The captured image data can be of any suitable file format that is well known in the art, such as PNG, RAW, BMP, JPEG, GIF, WMF, EMF, PostScript, PDF and PCL.

In some other embodiments, method 100 can be implemented as a part of a photo editing or text editing application program. The user gesture can be defined as a user request to perform any editing operation that is well known in the art. For example, if the digital content is displayed in a photo editing program, an image on the selected region can be generated, e.g., an image cropping operation, following the predetermined event. The cropped image can then be displayed in full screen automatically. The selected portion of an image can also be subject to any other predetermined image editing operation responsive to the predetermined event, such as automatic image enhancement, or brightness sharpness adjustment. Similarly, if the digital content is displayed in a word processing program, the text included in the selected region can be highlighted, copied to a clipboard, underlined, or tagged.

In still some other embodiments, the user gesture can be used to trigger other types of operations with respect to the digital content displayed in the selected region, such as sharing it through a social media website, or sending by email, etc.

In some embodiments, the manipulation operation resulting from the user gesture can be performed immediately and automatically following the predetermined event. In some other embodiments, an on-screen options menu can be presented following the predetermined event, from which the user can select an intended operation on the selected content.

Various types of user input can be processed as a predetermined event to confirm or commit the selection of a displayed region. In some embodiment, the event is that the gesture dwells on the touchscreen for another predetermined amount of time, which can trigger the manipulation operation, e.g., capturing and saving a screenshot or generating a cropped image. In some other embodiments, the user can submit an editing command by using a soft button (e.g., through an options menu) or a hard button on the keyboard that are designed to execute the predetermined manipulation operation.

It will be appreciated that the present disclosure is not limited to any specific type of digital content or visual object that can be selected for a manipulation operation responsive to a user gesture that capture a subset of the display screen image. For instance, a user gesture according to the present disclosure can be used to select a region from a screen display containing one or more of a webpage, a text document page, a still image, a video frame, a graphical user interface windows of any application program, etc.

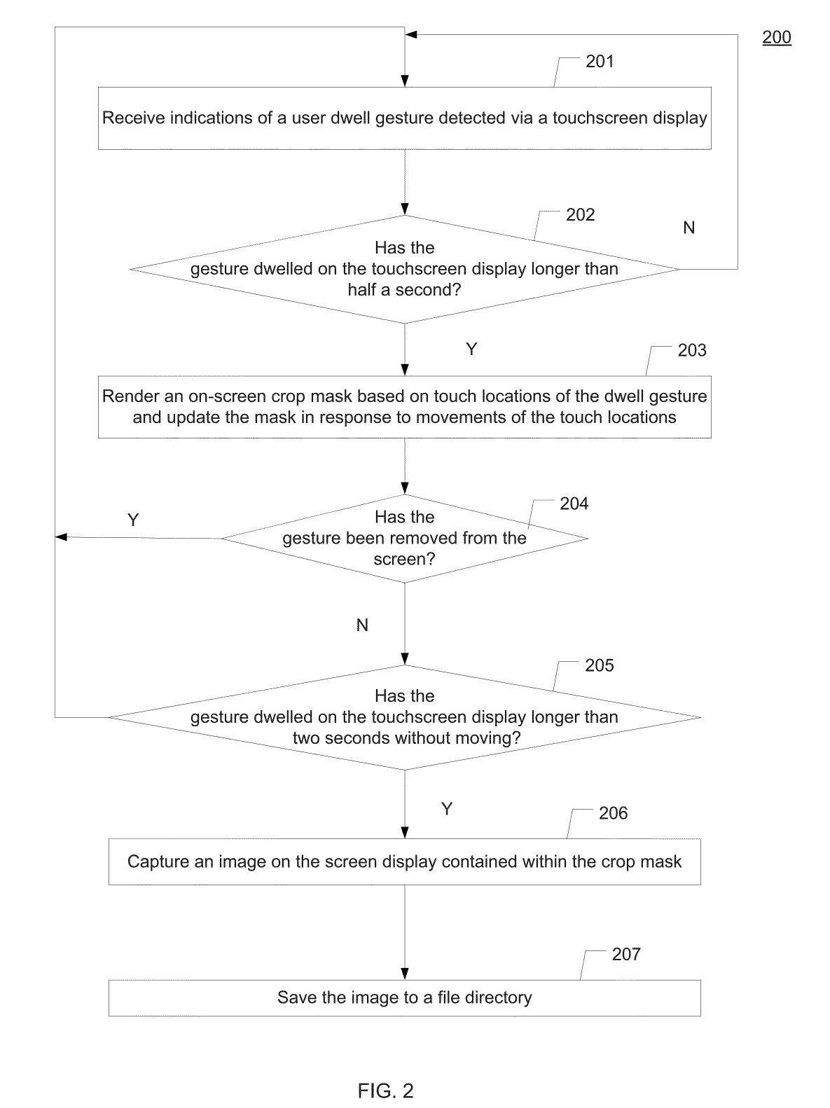

FIG. 2 is a flow chart depicting an exemplary computer implemented method 200 of capturing only a portion of a screen image being displayed on a touchscreen display according to an embodiment of the present disclosure. At 201, indications of a user dwell gesture detected via a touchscreen display are received.

If the detected gesture dwells on the touchscreen display for longer than half a second for instance, as determined at 202, an on-screen crop mask is generated based on and defined by the touch locations of the dwell gesture and rendered on the touchscreen display at 203. Further, the crop mask can be updated in response to movements of the touch locations.

If it is determined that the dwell gesture left the touch screen at 204, the mask is then removed from display. This terminates the image capture. On the other hand, if it is determined that the gesture has dwelled on the touchscreen display longer than two seconds without moving (at 205), then only the displayed content image contained in the crop mask is automatically captured as an image at 206, and saved to a file directory at 207. An on-screen indicia may be displayed to inform the user that a partial screenshot has been taken.

Thus, as a result of the forgoing process, a screenshot only on a select portion of the overall screen display is capture in response to a single and intuitive user gesture.

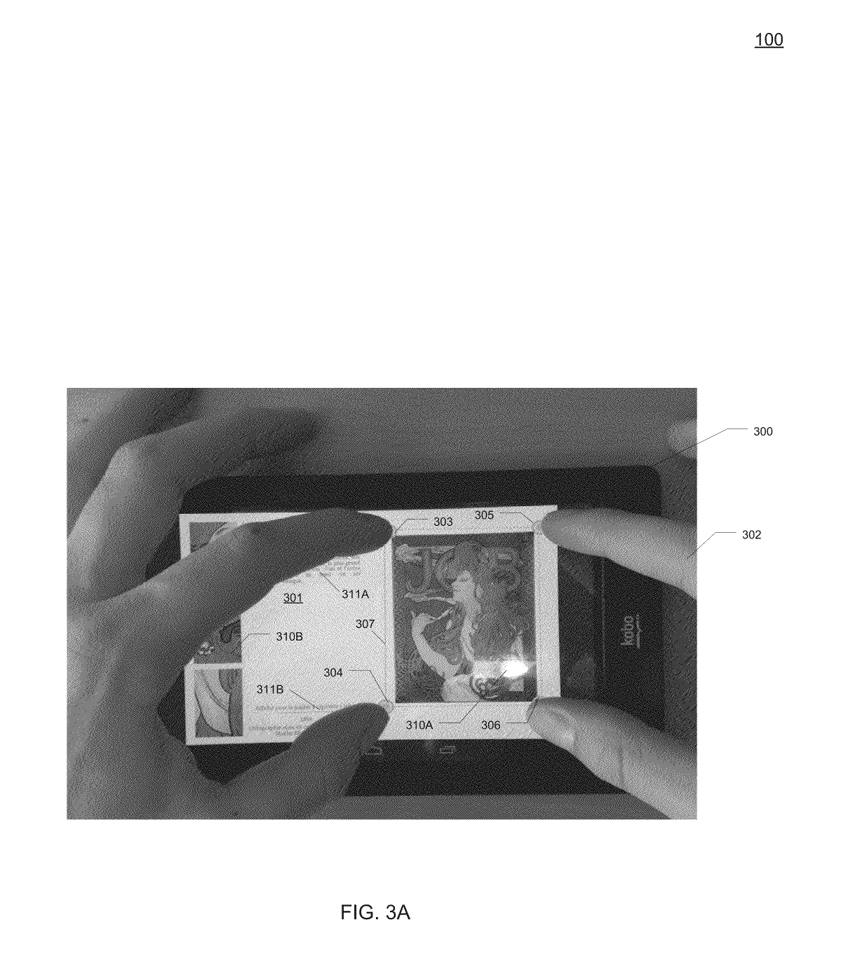

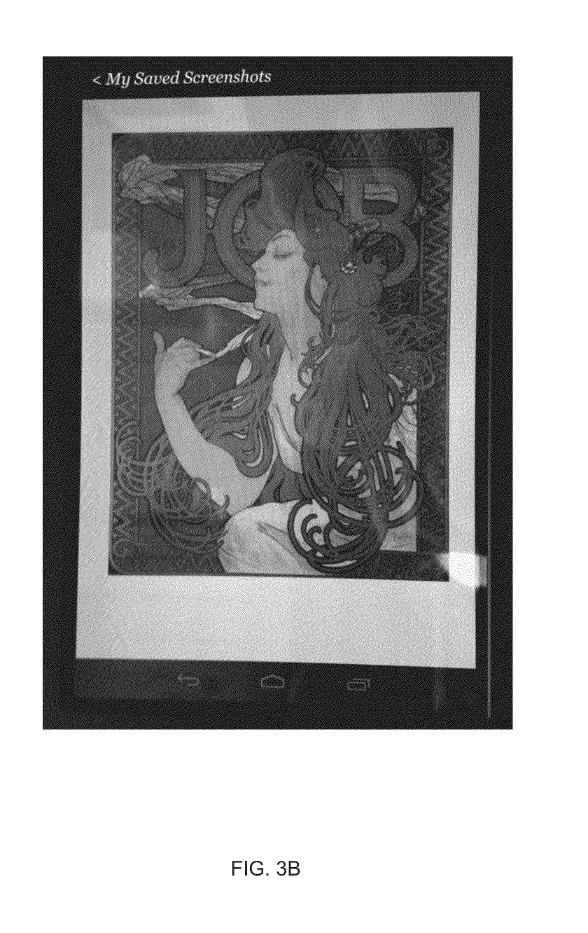

FIG. 3A illustrates a scenario that a user 302 selects a portion of a screen display 301 to capture a screenshot thereof by using a four-point touch gesture in accordance with an embodiment of the present disclosure. As shown, the tablet 300 is equipped with a touchscreen display 302 that is displaying the screen display 301. The entire screen display 301 includes several graphic sections (e.g., 310A and 310B), and text sections (311A and 311B).

The user 302 forms a four-point gesture by using the index fingers and thumbs. Once the user places the gesture around the graphic image 310A on the touchscreen 302 for a certain amount of time, a rectangular crop mask 307 is displayed with four corners coinciding with the four touch locations 303-306. If the gesture continues to dwell on the touchscreen 302 for another certain amount of time, a screenshot on the graphic image 310A is automatically capture only of image 310A, stored in memory, and displayed in full screen on the touchscreen 302. FIG. 3B illustrates the full screen display of the capture screenshot of the partial screen display in accordance with an embodiment of the present disclosure. The captured image can be saved to a default folder instantly or to a user specified folder. Thus, the user obtains an image on only an intended portion of a screen display by using a simple and intuitive gesture.

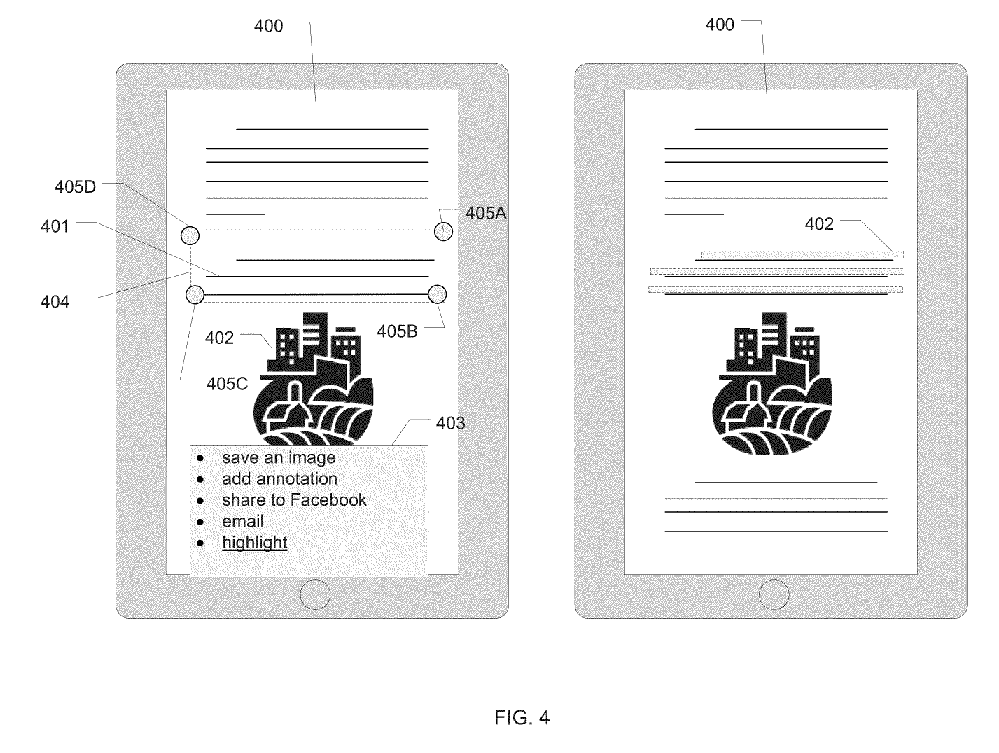

FIG. 4 illustrates an on-screen graphical user interface 400 including a text portion that is selected for a highlighting operation responsive to a user gesture in accordance with an embodiment of the present disclosure. The screen display includes a GUI 400 displaying text (e.g., 401) and an image (402). In response to a user selection gesture, e.g., four-point touch gesture with touch points 405A-D defined as illustrated, a, a rectangular selection mask 404 is displayed.

After the subset region 404 is defined by the gesture, an options menu 403 is automatically displayed on the GUI 400 providing the manipulating operations options of “save an image,” “add annotation,” “share to Facebook,” “email,” highlight” with respect to the selected portion 404 of the screen display (e.g., the text 401). If the user selects the option “highlight” from the menu 403, the text 401 is highlighted as shown in 402. Whatever option is selected from menu 403, the operation is applied only to the image/text within 404.

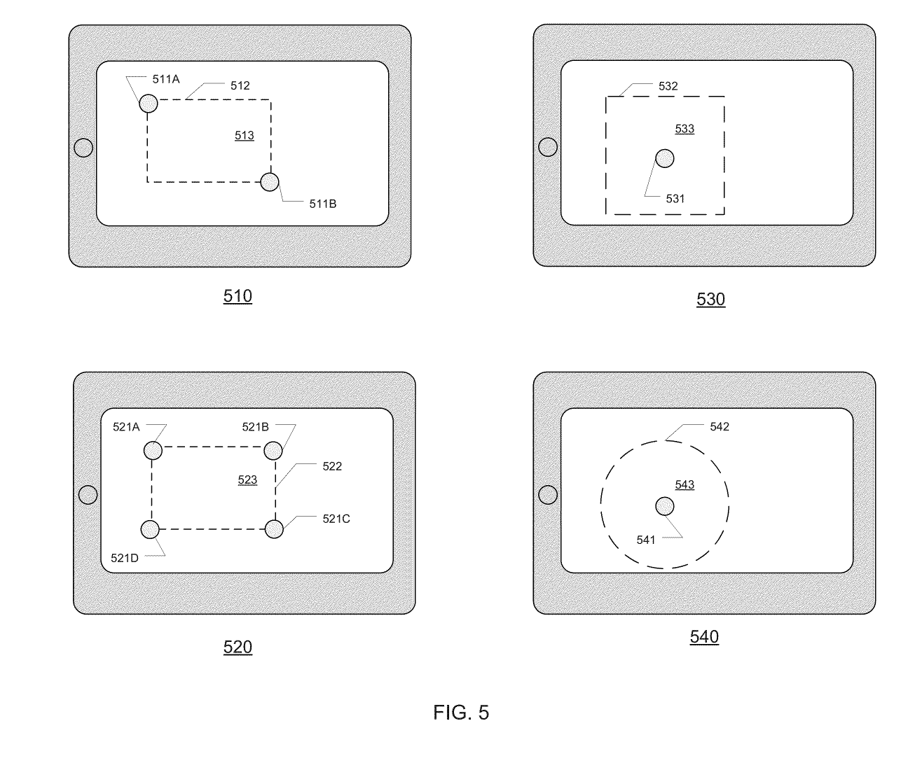

FIG. 5 illustrates various exemplary predetermined masks (512, 522, 532, and 542) prompted by different touch gestures in accordance with embodiments of the present disclosure. Diagram 510 shows that a detected two-point touch gesture defines a rectangular region 513. The mask 512 marks the boundaries of the rectangular region with a pair of diagonal corners coinciding with the two touch locations 511A and 511B of the user gesture.

Diagram 520 shows that a detected four-point touch gesture defines a rectangular region 523 with the four corners coincide with the four touch-points 521A-521B of the gesture. It will be appreciated a rectangular regions can be determined by a four-point gesture even if the touch points only coincide with corners of a rectangle in approximation.

Diagram 530 shows that a detected one-touch gesture can define a square region 533 centering the touch location 531. Diagram 540 shows that a detected one-touch gesture can define a circular region 543 centering the touch location 541. The square mask 532 and circular mask 542 may be displayed in predetermined dimensions until being adjusted by the users.

It will be appreciated that various shapes of selection regions can be defined in response to detection of a user touch gesture, depending on the configuration of an application program. Further, an application program may be operable to recognize more than one touch gesture and process them as user requests to select different shapes of regions.

The method of selecting a portion of a screen display for a manipulation operation according to boundaries set by a user gesture can be implemented on any suitable electronic device and in association with any suitable operation system. The electronic device can be a desktop, portable computers, personal digital assistance (PDAs), mobile, phone, e-readers, touchpads, tablets, and etc.

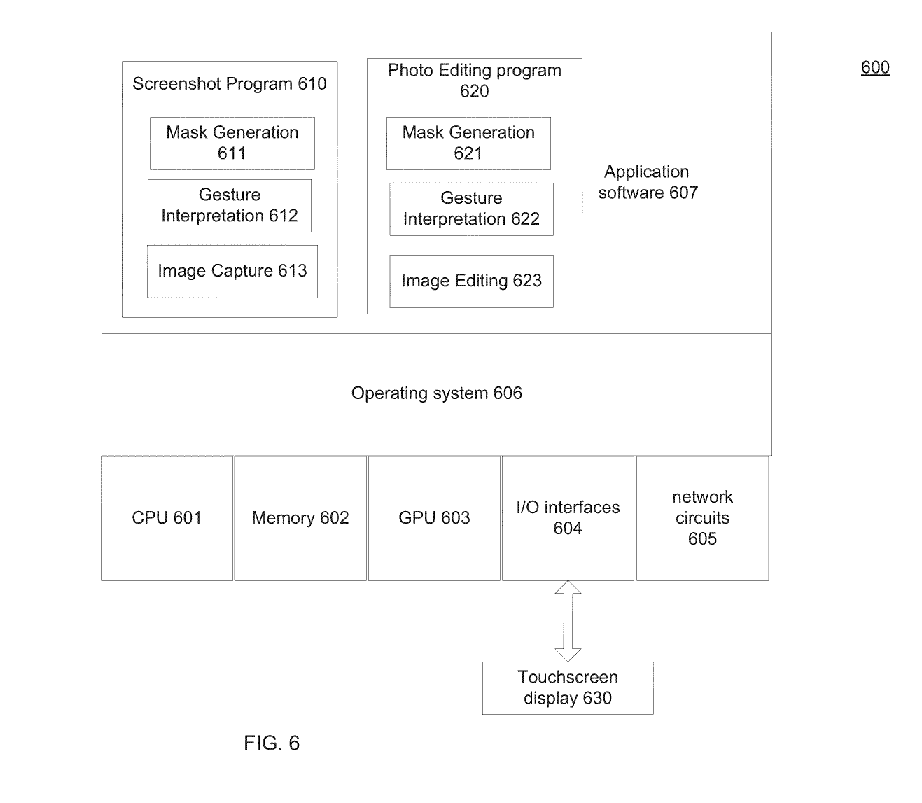

FIG. 6 is a block diagram illustrating an exemplary computing system 600 including a screenshot program 610 configured to capture a partial screen display responsive to a user touch gesture according to an embodiment of the present disclosure. The computing system 600 comprises a processor 601, system memory 602, a GPU 603, I/O interfaces 604, network circuits 605, an operating system 606 and application software 607 including the screenshot program 610 stored in the memory 602.

The application software 607 also includes a photo editing program 620 configured to edit a selected portion of an image responsive to a user touch gesture according to an embodiment of the present disclosure. The touch gestures that can be recognized in the screenshot program 610 and the photo editing program 620 may be different. In some other embodiments, a screenshot program according to the present disclosure can be implemented in the operation system 606.

The computing system 600 is equipped with a touchscreen display 600 coupled to the processor 601 through an I/O interface 604. For purposes of practicing the present disclosure, any well known touch screen technology can be used to receive a specified user gesture as a user instruction to select a portion of a screen display for a manipulation operation. The technology of the present disclosure is not limited by any particular type of touch-sensing or proximity-sensing mechanism employed by the touchscreen 630. The touchscreen 630 can be a resistive touchscreen, a capacitive touchscreen, an infrared touchscreen, or a touchscreen based on surface acoustic wave technology, etc. A user touch gesture through a touchscreen can be detected, processed, and interpreted by any suitable mechanism that is well known it the art.

In the illustrated example, the screenshot program 610 comprises modules respectively configured for mask generation 611 gesture interpretation 612 and image capture 613. Upon receiving indications of a user touch gesture (e.g., a four-point touch gesture or a single touch gesture) detected via the touchscreen display 630, the gesture interpretation module 612 is configured to decide whether to interpret the gesture as a user request for image capture. Then, based on the indications of touch locations, the gesture interpretation module 612 can determine a capture region with a certain dimension and location with reference to the current screen display, such as a rectangular region or a circular region. The mask generation module 611 can access the determined capture region and present an on-screen capture mask to indicate the boundaries of the capture region.

The gesture interpretations module 612 can further alter the capture region if the touch locations are changed, for instance because the user adjusts the hand gesture as a request to alter the capture region. Accordingly, the mask generation 613 can update the capture mask to reflect the alteration.

Similarly, the photo editing program 620 includes a mask generation module 621, a gesture interpretation module 622, and an image editing module 623. In response to detection of a recognizable user gesture, the gesture interpretation module 622 can determine an active region for editing based on the touch locations. Then the mask generation module 621 can present a selection mask showing the boundaries of the active region.

In some embodiments, a recognized gesture is only associated with a particular editing operation, e.g., cropping. For example, if the touch gesture dwells on the touchscreen display 630 for a certain amount of time, the image being displayed in automatically cropped based on the active region. In some other embodiments, a recognized gesture can prompt an options menu from which a user can select an editing operation with respect to the active region, as shown in FIG. 4.

The screenshot program 610 and photo editing program 620 may perform various other functions as discussed in details with reference to FIG. 1-5. As will be appreciated by those with ordinary skill in the art, the screenshot program 610 and photo editing program 620 including the various function modules 611-613 and 621-623 can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of generating images, said method comprising:
receiving indications of a multi-touch user gesture detected via said touch sensitive display device of a computer system, wherein said indications indicate touch locations of said multi-touch user gesture with said touch sensitive display device;
based on said touch locations, determining a region within a display area of said touch sensitive display device;
rendering an on-screen mask indicating boundaries of said region; and
upon occurrence of a predetermined event, generating image data capturing only a portion of a screen image being displayed on said touch sensitive display device, said portion encompassed by said region.

2. The computer implemented method of claim 1, wherein said multi-touch user gesture defines four touch locations, and wherein further said determining said region comprises determining a rectangle with four corners based on said four touch locations.

3. The computer implemented method of claim 1, wherein said multi-touch user gesture defines two touch locations, and wherein further said determining said region comprises determining a rectangle having a pair of diagonal corners based on said two touch locations.

4. The computer implemented method of claim 1, wherein said predetermined event is a determination that said multi-touch user gesture dwells on said touch sensitive display device for at least a predetermined duration.

5. The computer implemented method of claim 1 further comprising rendering said image data to display on said touch sensitive display device in full screen.

6. The computer implemented method of claim 1 further comprising saving said image data as an image file to a default directory of said computing system.

7. The computer implemented method of claim 6 further comprising rendering indicia indicating that said image data has been saved.

8. The computer implemented method of claim 1 further comprising removing said on-screen mask responsive to said multi-touch user gesture leaving said touch sensitive display device without detecting said predetermined event.

9. The computer implemented method of claim 1, wherein said screen display presents digital content comprising one or more of text, an image, a graphical user interface, a video, and a webpage.

10. A non-transitory computer-readable storage medium embodying instructions that, when executed by a processing device, cause the processing device to perform a method of capturing an image of a touch display, said method comprising:
receiving indications of a multi-point gesture detected via a said touch display, wherein said indications provide contact positions of said multi-point gesture on said touch display;
based on said contact positions, determining a rectangular display region within said touch display;
rendering an on-screen mask indicating boundaries of said rectangular display region; and
responsive to a user input event, providing a partial screen display that is being displayed on said touch display and contained within said on-screen mask to a manipulation operation.

11. The non-transitory computer-readable storage medium of claim 10, wherein said on-screen mask comprises a rectangle formed by dotted lines.

12. The non-transitory computer-readable storage medium of claim 10, wherein said multi-point gesture is a four-point gesture, and wherein said contact positions correspond to four corners of said rectangular display region.

13. The non-transitory computer-readable storage medium of claim 10, wherein said user input event comprises said multi-point gesture dwelling on said touch display for a predetermined time, and wherein said manipulation operation is capturing said partial screen display.

14. The non-transitory computer-readable storage medium of claim 13, wherein said method further comprises rendering a graphical user interface configured to receive user input to save captured partial screen display to a directory.

15. The non-transitory computer-readable storage medium of claim 13, wherein said method further comprises rendering a graphical user interface configured to receive a user instruction to share said captured partial screen display.

16. The non-transitory computer-readable storage medium of claim 10, wherein said user input event comprises said multi-point gesture dwelling on said touch display for a predetermined time, and wherein said manipulation operation is changing a display format of text content encompassed by said rectangular display region.

17. A system comprising:
a touch sensitive display device configured to detect user gesture input;
a processor coupled to said touch sensitive display device;
memory coupled to said processor and comprising instructions that, when executed by said processor, cause the system to perform a graphical user interface method, said method comprising:
receiving indications of a multi-touch gesture detected via said touch sensitive display device, wherein said indications indicate touch locations of said multi-touch gesture with said touch sensitive display device;
based on said touch locations, determining a capture region within said touch sensitive display device;
rendering an on-screen mask indicating boundaries of said capture region; and
responsive to a user instruction, capturing an image within a portion of said touch sensitive display device being displayed, said portion encompassed by said capture region.

18. The system of claim 17, wherein said multi-touch gesture defines four touch locations, and wherein further said determining said capture region comprises determining a rectangle with four corners corresponding to said four touch locations.

19. The system of claim 18, wherein said method further comprises saving said image as a JPEG file to a default directory of said memory.

20. The system of claim 17, wherein determining a capture region comprises altering said capture region responsive to movements of said touch locations, and wherein said user instruction comprises said touch locations remaining constant for a predetermined amount of time.
